(19) United States
(12) Patent Application Publication
(10) Pub. No.: US 2011/0208801 A1
(43) Pub. Date: Aug. 25, 2011

(54) METHOD AND APPARATUS FOR SUGGESTING ALTERNATE ACTIONS TO ACCESS SERVICE CONTENT

(75) Inventors: Haraldur Thorkelsson, Kopavogur (IS); Nikolai Grigoriev, Brossard (CA); Sylvain Fortin, St.-Laurent (CA)

(73) Assignee: Nokia Corporation, Espoo (FI)

(21) Appl. No.: 12/708,812

(22) Filed: Feb. 19, 2010

(51) Int. Cl. G06F 15/16

(52) U.S. Cl. 709/203; 715/764

(57) ABSTRACT

An approach is provided for suggesting an alternate action associated with service content. The suggestion platform receives a request, from a device, for accessing service content. Next, the suggestion platform determines at least one alternate action associated with the service content. Then, the suggestion platform suggests the alternate action for accessing the service content.

### BACKGROUND

Software developers and device manufacturers are continually challenged to deliver value and convenience to consumers by, for example, providing compelling network services and advancing the underlying technologies. One area of interest has been the development of rich internet applications (RIAs) for delivery of these services and related service content (e.g. web content, functions, actions, etc., related to or provided by the services). Because RIAs generally execute or are accessed using a web browser application, RIAs enable, for instance, the development of platform independent services and related applications that can run on a variety of web-enabled devices. However, such RIAs are also often affected by the limitations of the web browser on which they are intended to run (e.g., lack of direct access to local device data or functions of the device). It is noted that in many cases, native applications or other client applications may provide functions equivalent to those of the RIAs often without the limitations suffered by the RIAs, although the sacrificing generally compatibility. Accordingly, service providers and device manufacturers face significant technical challenges in integrating the functions of RIAs and native device applications to provide services and related service content.

### SOME EXAMPLE EMBODIMENTS

Therefore, there is a need for an approach for suggesting alternate actions to access service content.

According to one embodiment, a method comprises receiving a request, from a device, for accessing service content. The method also comprises determining at least one alternate action associated with the service content. The method further comprises suggesting the alternate action for accessing the service content.

According to another embodiment, an apparatus comprising at least one processor, and at least one memory including computer program code, the at least one memory and the computer program code configured to, with the at least one processor, cause, at least in part, the apparatus to receive a request, from a device, for accessing service content. The apparatus is also caused to determine at least one alternate action associated with the service content. The apparatus is further caused to suggest the alternate action for accessing the service content.

According to another embodiment, a computer-readable storage medium carrying one or more sequences of one or more instructions which, when executed by one or more processors, cause, at least in part, an apparatus to receive a request, from a device, for accessing service content. The apparatus is also caused to determine at least one alternate action associated with the service content. The apparatus is further caused to suggest the alternate action for accessing the service content.

According to another embodiment, an apparatus comprises means for receiving a request, from a device, for accessing service content. The apparatus also comprises means for determining at least one alternate action associated with the service content. The apparatus further comprises means for suggesting the alternate action for accessing the service content.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of suggesting alternate actions to access service content, according to one embodiment;

FIG. 2 is a diagram of the components of the suggestion platform 107, according to one embodiment;

FIGS. 3A-3B are flowcharts of a process for suggesting alternate actions to access service content, according to one embodiment;

FIG. 4 is a flowchart of a process for suggesting equivalent service content, according to one embodiment;

FIG. 5 is a flowchart of a process for performing an action specified in the service content using an alternate application, according to one embodiment;

FIGS. 6A-6D are diagrams of user interfaces utilized in the processes of FIG. 3, according to various embodiments;

FIG. 7 is a diagram of user interfaces utilized in the processes of FIG. 3, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for suggesting alternate actions to access service content are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

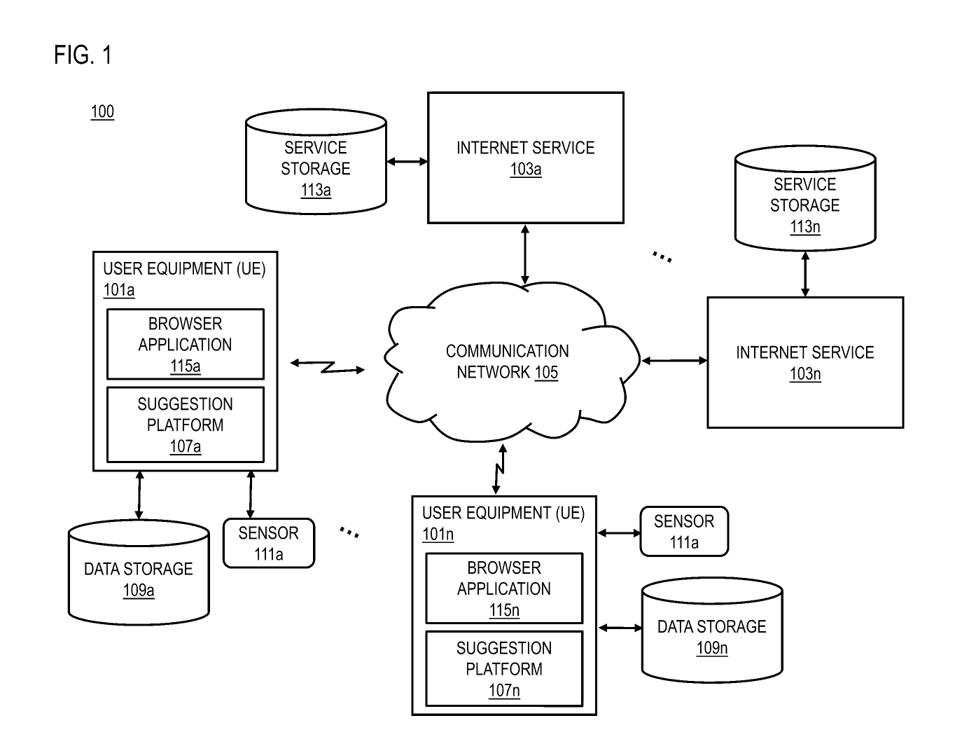

FIG. 1 is a diagram of a system capable of suggesting alternate actions to access service content, according to one embodiment. As discussed previously, the development of rich internet applications (RIAs) has enabled the implementation of a wide range of applications (e.g., email clients, mapping services, photo processing, etc.) in a web browser environment that were historically only accessible using applications running locally on device. While these RIAs and related service content (e.g. web content and any other functions, actions, and the like provided by the services) provide certain advantages (e.g., portability across multiple devices, general compatibility, etc.), a native or client application can often provide an alternate method or can perform alternate actions (e.g., prompt user for additional information, modify the content of a web page being displayed, launch other applications, block access to specific pages, and the like) to access service content of a website or web service. It is noted that using such native or client applications is generally more efficient and/or convenient than accessing the same content using a rich internet application (RIA) over a conventional web browser. It is further noted that the performance gap between browser-based RIAs and equivalent native applications is generally much wider on platforms with limited resources (e.g., processing resources, memory, bandwidth, etc.) such as a mobile device. When native or client applications are well-designed for a particular platform or device, the primary causes of this performance gap include: (1) client applications are generally capable of providing richer and platform-optimized user experience (e.g., look and feel, full usage of platform controls and functions, maximum usage of available display area, etc.); (2) client application generally store data more efficiently than RIAs or web browsers; (3) client applications generally use network resources more efficiently because the protocols they use are usually more domain-specific because such applications need not exchange user interface related resources (e.g., graphical resources, audio resources, etc.) because the user interface elements would be already locally installed; (4) client applications usually can provide a higher level of security than RIAs or web browsers; (5) client applications can be optimized with respect to policies imposed by the network operator (e.g., resources restrictions, security policies, access policies, etc.); (6) client applications are better integrated with the available resources of the platform (e.g., a client application can access a local camera module unlike general web-based RIAs); (7) client applications enable offline access to a particular service; and the like.

In other words, client applications provide richer and platform-optimized user experience in many aspects including visualization, convenience, flexibility, security, and speed. For example, client applications generally use network resources (e.g. bandwidth) more efficiently because they are designed more specifically for their respective domains (e.g., device capabilities). Further, client applications generally are easier to integrate with a local device, and provide better security and access to device functions and hardware, partly because the client applications are usually designed specifically to the local device. For example, a client application generally can be well-integrated with device components (e.g., a camera and a microphone existing in the local device), and enables easy upload from or download to the local device. Also, because the client applications may have access to user information stored in the device, such as the user's phone number, name and user profile information as well as secure information like user's credit card information, this information may be automatically accessed by the client application and reduces of burden on the user to enter this information. In addition, some of the functionalities by the RIAs may be implemented in the client application in a more optimized form that is specific to the capabilities and functions of the local device.

Despite these advantages of client applications, it is noted that client applications may not be as widely used as their equivalent RIAs due to various reasons. By way of example, users are often unaware of the availability of client applications, other alternate access methods, application data access policies and rules, cost of service, integration paths between the RIA and the functionality offered by a device or platform, and the like. In particular, users may not be aware of existence of client applications even if the client applications are already installed within a device. In some cases, even if the client applications are not pre-installed in the device, the client applications may be retrieved from another source, such as a website or another device, often at no cost to the user. However, many users are not willing to spend time to look for alternate ways to access the website because of the burden associated with accessing, using, and/or acquiring such client applications, even if the client applications provide a better user experience than the equivalent RIA. For example, a user may often continue using the same web service access patterns (e.g., access a web service via RIAs) on the user's mobile device as used on list resource-restricted devices (e.g., personal computers) without considering whether a client application executing on the mobile device would provide a better experience. As a result, the user may forfeit the advantages (e.g., as discussed above) offered by such applications or any other available alternate actions associated with the web service, particularly on mobile devices.

Further, users often cannot easily determine whether a specific website, service, or RIA has a client, native application, or other alternate actions available. Although some websites provide information on available client applications, this information is often not easily visible and users generally do not spend time to look for available client applications. Users particularly have difficulty in finding client applications if the client applications are developed by a third party rather than, not by the provider of the website. It is noted that alerts, such as push notifications (e.g. SMS, WAP push), informing users of the availability of applications are often ignored or dismissed by users. In addition, some users do not realize the advantages of the client applications, and sometimes misunderstand that client applications are costly to acquire or use. For example, users often assume that using client applications will cost them more than just using a web browser. However, users typically do not consider all aspects of “costs” involved. In one example, battery life on the user's device can depend, at least in part, on how and how much data is transferred while using either the application or the RIA. For RIAs that are not typically optimized for the mobile device, it is common that the browser has to download a considerable amount of data (e.g., 1 MB or more) per web page. In contrast, a client application may use only a few percent or less of the amount of data to display the same amount of information. Another aspect of cost is the actual cost of service for the network operator. Network operators are, for instance, generally interested in deploying client applications to reduce bandwidth usage and load on their networks. Client applications can also provide more control over how a particular web service is accessed by the user so that network operators can better regulate overall network load.

Another problem with accessing RIAs rather than equivalent client applications is related to the fact that RIAs perform functions in a platform-neutral because they typically run only in a web browser. As such, the web browser is generally the only piece of software that interacts with the RIA and the user on the clientside or device. For example, if a RIA offers a function such as “share over SMS”, the RIA typically displays a prompt that asks the user for the recipient's phone number and then sends the requested text message from the web server or other service provider. However, it generally would be more convenient if instead of this web-based form, the user is presented with the native text messaging application on the user's device. In this way, the native text messaging application would have access to the device's address book, provide a better message composition experience, spools the outgoing message locally, uses the correct “from” number in the text message, etc.

Accordingly, many users do not enjoy the enhanced user experience and increased efficiency (e.g., decreased bandwidth use, processor use, etc.) potentially available from using client applications or any other alternate actions for accessing the service content. Instead, users often continue to use regular websites and/or RIAs, which may cost more network resources and may be more inconvenient and slower than the client applications. Similarly, users may not be aware of alternate actions (e.g., presenting more resource intensive versions of requested content, enabling access to information stored a user device, etc.) that can enhance user experience in accessing the service content.

To address this problem, a system 100 of FIG. 1 introduces the capability to analyze the service content of a web page (e.g., part of the RIA) to suggest alternate action to access the service content (e.g., launching a client application, suggesting an alternate website with similar service content, suggesting equivalent content such as a mobile or light version of the service content, etc.), and then interrupt the normal user interface flow of the web page or RIA to present the suggestion or other highly relevant information. In other words, the system 100 determines the context in which service or web content is accessed, monitors for a triggering event (e.g., loading a web page, selecting a link, highlighting content, scrolling through content, leaving a page, etc.) to suggest one or more alternate actions, and then initiates the alternate actions based on user input. More specifically, system 100 enables the UE 101 to acquire information about a website (e.g., by parsing the content of the website, determining context information associated with the website and/or the device, etc.) provided by one of the internet services 103a-103n, as the UE 101 accesses the service content of the website. Then, the system 100 determines alternate actions that corresponds to or is based, at least in part, on the acquired information about the website. The system 100 further suggests the alternate actions to the user for accessing the service content or performing one or more functions of the corresponding RIA. In certain embodiments, the system 100 may suggest using a less resource intensive version of the service content (e.g., a mobile-device optimized version of the service content in place of the original version of the service content).

In one embodiment, the system 100 may suggest launching a client application and further suggest a list of client applications that correspond to the website and are installed in the UE 101, as a user attempts to access the website, web service, and/or RIA. The system 100 may consider information from the website to determine client applications that correspond to the website. For example, the system 100 may determine that an accessed website provides a messaging function by searching for information in the website related to creating an email or other message. The system 100 can then suggest use of the native messaging application of the UE 101 in place of a web-based email function. Accessing the native messaging application can, for instance, enable access to the native contact list of the UE 101 so that the user need not manually input or otherwise provide the contact information into the web-based messaging function. In this way, the system 100 advantageously reduces the information that the user has to provide to use such as function.

Further, the system 100 may also consider other information (e.g., context information) in suggesting the use of equivalent client applications. For example, the system 100 may determine the amount of bandwidth available to the UE 101 as part of determining context information. If there is limited bandwidth, the system 100 may suggest use of a more bandwidth-efficient client application in place of the requested RIA or website. The system may also suggest a list of client applications that can be retrieved and installed in the UE 101 but do not exist within the UE 101. This list of client applications may be, for instance, available for download from an online application store (e.g., Nokia's Ovi Store) or other source (e.g., transfer from a peer device, application kiosk, etc.).

In another embodiment, the system 100 may suggest browsing another website that is equivalent to the website with web content, as an alternate action to access the website. The system 100 may consider device environment as well as the website information to make this suggestion. For example, in one embodiment, if the device's internet bandwidth is limited, then the system 100 may suggest an equivalent website (e.g., a mobile-optimized version or a light version of the website) that does not use as much bandwidth to load. Thus, the equivalent website may contain similar service content to the regular website.

In yet another embodiment, the system 100 may suggest an alternate action to access a web link from a website. For example, if a user clicks on a link or an icon that directs the user to a second website, then the system 100 may suggest alternate method to access the second website. The alternate action for accessing the web link may include client applications, alternate versions of the web link, alternate sources, etc. as described above.

Therefore, an advantage of this approach described herein is that a user can easily be informed of available alternate actions for accessing service contents, even when the user is not aware of such alternate methods. In one embodiment, the alternate action or actions may be presented as a pop up window, text box, or the like to alert the user of the available of the methods. The user can then select whether to use the suggested alternate. In addition, it is contemplated that the user may configure the system 100 to enable or disable the suggestions. In one embodiment, the suggestions may be enabled on a per site or service basis or on a system wide basis. It is also contemplated that the approach described herein can be implemented entirely within the user device (e.g., as a device-based application, module, process, etc.). In this way, all processing and monitoring of user actions occur only on the device side, and no information about the user's actions or service preferences are shared outside of the device to enhance user privacy.

As previously noted, the alternate actions may allow accessing service content more efficiently and/or provide more sophisticated features in accessing the service contents. As a result, this approach enhances the user experience in accessing service contents by encouraging users to explore alternate actions in accessing the service contents. Therefore, means for suggesting alternate actions for accessing service contents is anticipated.

As shown in FIG. 1, the system 100 comprises a user equipment (UE) 101 having connectivity to one or more internet services 103a-103n via a communication network 105. In one embodiment, the services 103a-103n provide web services and/or related service content (e.g., email service, messaging service, music service, mapping service, video service, social networking service, etc.) for access by the UE 101. By way of example, the services 103a-103n may be accessed via RIAs which are web-based applications delivered over a web browser via a web application framework such as Ajax, Curl, Adobe Flash, Java, etc. Each of the services 103a-103n may in turn have connectivity to the respective service storage databases 113a-113n for storing service content and related information (e.g., user profile information, user accounts, etc.).

The UE 101 may include a suggestion platform 107 and a browser application 115. In one embodiment, the suggestion platform 107 executes within the UE 101 to determine an alternate action to access a service content of a website when the UE 101 attempts to access the service content provided by one or more of the internet service 103a-103n. In addition or alternatively, the suggestion platform 107 may operate independently of the UE 101 as a separate component (not shown) of the communication network 105 or as a part of another component (not shown) of the communication network 105, although it is preferred that the UE 101 is a separate component. By way of example, if the UE 101 accesses an internet service 103a that is a social networking services such as www.facebook.com (Facebook) using a browser application 115, the suggestion platform 107 can suggest accessing the Facebook service using a local Facebook client application rather than via the Facebook website using the browser application 115 such as a web browser (e.g., as a Facebook RIA). Furthermore, the suggestion platform 107 may suggest alternate actions that are available for accessing the service content. For example, the suggestion platform 107 may suggest launching the client application if the client application is already installed within the UE 101. If the client application does not exist within the UE 101, then the suggestion platform 107 may suggest retrieving the client application. The client application may be downloaded from the internet service 103a, which has a service storage medium 113a storing the client application as well as other information. The client application may also be downloaded from another UE 101 having a data storage 109 storing the client application. Further, the internet service 103a may also be a website or application store (e.g., Nokia's Ovi Store) dedicated to distributing client applications. For example, the internet service 103a may be a website that has a client application developed by either Facebook itself or another third party developer.

In another embodiment, the UE 101 may collect information from the sensor 111 as well as any other information regarding a context such that the suggestion platform 107 may determine the context information and use the context the information in determining of an alternate action to access the service content of the website. The suggestion platform 107 may also provide options to access another service content or another website that is equivalent to the initial service content or the website that the UE 101 accesses.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 101 can support any type of interface to the user (such as “wearable” circuitry, etc.).

By way of example, the UE 101 and the internet service 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the client application executing on the UE 101 and the internet service 103 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

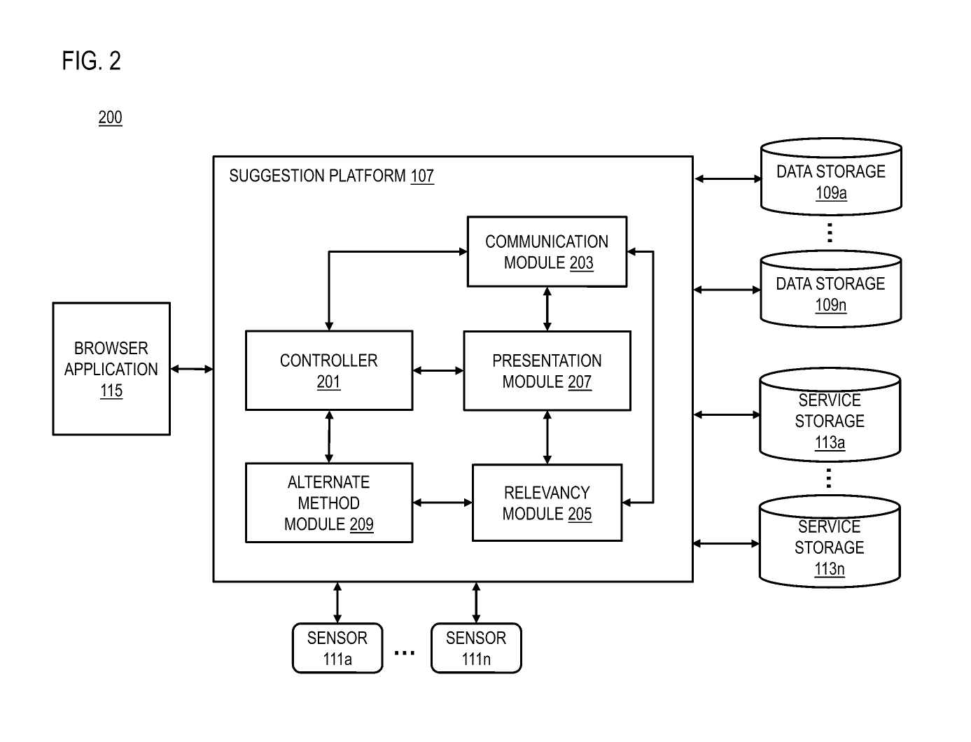

FIG. 2 is a diagram of the components of the suggestion platform 107, according to one embodiment. By way of example, the suggestion platform 107 includes one or more components for suggesting alternate action to access service content. It is contemplated that the functions of these components may be combined in one or more components or performed by other components of equivalent functionality. In this embodiment, the suggestion platform 107 includes a controller 201 which executes at least one algorithm for executing functions of the suggestion platform 107, a communication module 203 for coordinating web service requests, a relevancy module 205 for analyzing requested service content determining suggested client applications or other alternate actions for accessing the content, a presentation module 207 for presenting the determined suggestions, and an alternate method module 209 for interfacing with selected client applications or alternate methods for service content access. More specifically, the controller 201 interacts with the communication module 203 to detect or monitor when the UE 101 accesses service content over the Internet. For example, the communication module 203 may receive or detect a request for accessing the service content available via the internet service 103. As noted earlier, the triggering event or request for accessing the service content may be indicated by various actions including loading a website, selecting a link to a website, highlighting a portion that references a website, scrolling to a section that references a website, as well as leaving a website. Because the browser application 115 may be used to access the service content, the browser application 115 and the communication module 203 may also interact to receive or detect the request for accessing the service content. The service content, for instance, may be associated with or provided by a RIA that is part of the internet service 103, wherein the RIA may be executed using the browser application 115. For example, the detection may be performed by intercepting a request by the browser application 115 for a specific universal resource locator (URL) or other network address associated with the internet service 103.

On such a detection, the controller 201 directs the relevancy module 205 to determine a relevancy between the service content and the available alternate actions such as client applications. For example, the relevancy module 205 may match the detected URL against the metadata associated with a suite of available client applications or other available alternate actions. In one example, if the detected URL is www.facebook.com, the relevancy module 205 determines whether a client application associated with the Facebook web service is installed in the UE 101 or otherwise available for download to the UE 101. In certain embodiments, the relevancy module 205 may also determine whether the alternate actions should be suggested or not, depending on the policy rules provided by an operator of the network service and/or the user of the UE 101. For example, the network operator may impose a policy that directs the suggestion platform 107 to always suggest client applications if available to encourage users to use more efficient client applications to reduce or manage traffic loads. In another embodiment, the relevancy module 205 may also use context information such as context information associated with the UE 101, the internet service 103, the communication network 105, or a combination thereof to determine whether to suggest alternate actions for accessing service content. This context information may be determined using, for instance, the sensor 111 (e.g., location sensor, environmental sensor, etc.) of the UE 101 or another one of the internet services (e.g., mapping service, weather service, etc.). It is also contemplated that context information may include other characteristics of the UE 101 including the data plan associated with the UE 101, additional accessories attached to the UE 101, the UE 101's current location, etc. For example, if context information indicates that network traffic is high or the UE 101 is located in an environment with slower network access, the relevancy module 205 may determine that suggesting alternate actions is appropriate. In yet another embodiment, the relevancy module 205 may suggest other equivalent service content (e.g., a mobile-optimized version of the service content, content from alternate web server with less network traffic, etc.) based on the requested service content and/or determined context information.

Using the results from the relevancy module 205, the controller 201 directs the presentation module 207 to present one or more of the determined suggestions to the user. In one embodiment, the presentation module 207 may display a pop-up window showing some or all of alternate action to access the service content. For example, the presentation module 207 may inject additional content (e.g., HTML or JavaScript code that provides additional UI components) into the requested service content without disrupting the normal web page logic. In addition or alternatively, the presentation module 207 may modify the requested service content or web page to display the suggested alternatives. As mentioned previously, the alternate actions may include launching a client application as an alternate application and another equivalent service content. The presentation module 207 may display information that may be helpful to users in determining which action the user should select in accessing the service content. This information can include location of the client application, cost of the client application, resources (e.g., bandwidth, memory, etc.) that would be saved based on using one or more of the alternatives. If a suggested client application is not already installed on the UE 101, the presentation module 207 interacts with the alternate method module 209 to download or suggest download of the application by communicating with, for instance, the service storage 113 of the internet service 103 to retrieve the application. Alternatively, the alternate method module 209 may communicate with a data storage 109 of another UE 101 to retrieve the application from the UE 101. If the user selects one or more of the suggested alternatives, the alternate method module 209 launches the alternate client action associated with the service content.

In one embodiment, it is contemplated that service content is received at the UE 101 unaltered (e.g., HTML code associated with the content is not altered at the internet service 103a). Instead, the content detection and suggestion process described above take place entirely within the UE 101. Thus, these processes are performed based on the information provided to the UE 101 by the communication network 105. The suggestion platform 107a can then take the unaltered content and modify the way it is displayed on the UE 101 based on user selection of the corresponding suggested actions. Further, because these processes are performed within the UE 101, information used in these processes is kept within the UE 101 without being leaked into the communication network 105, and thus the user's privacy is protected.

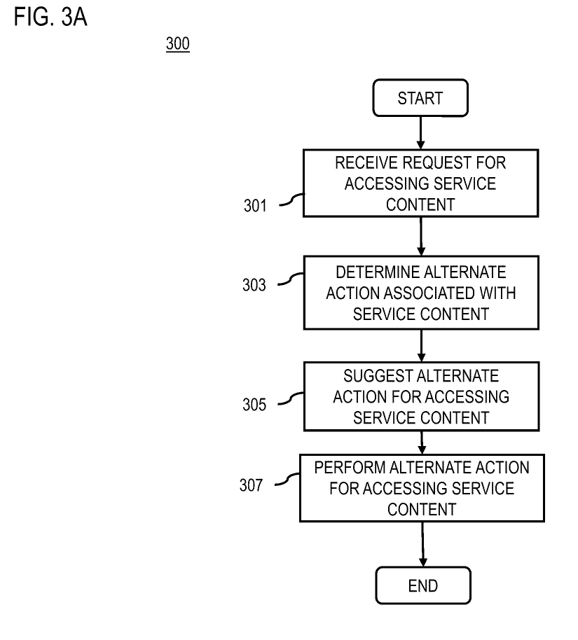

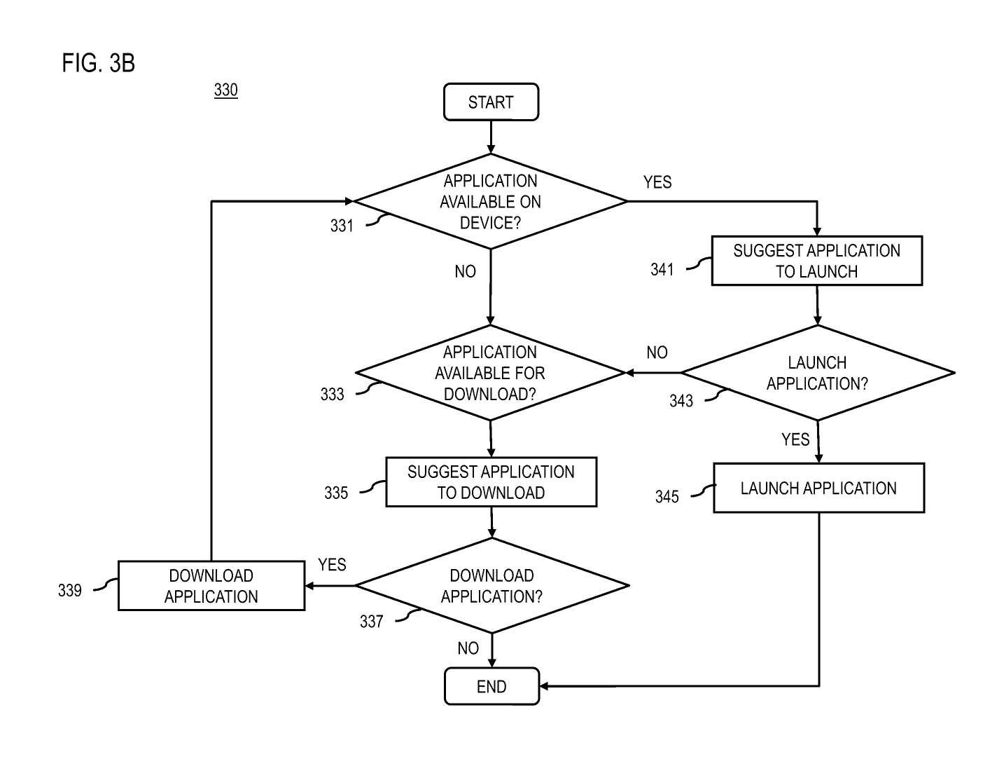

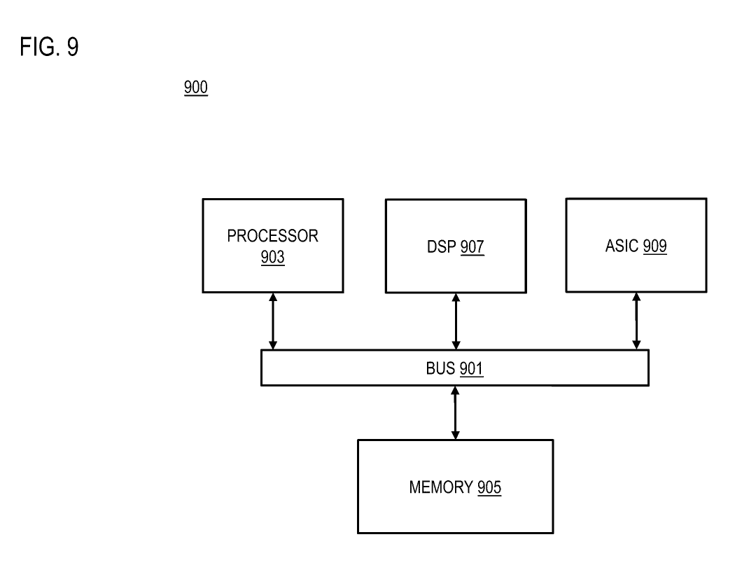

FIGS. 3A-3B are flowcharts of a process for suggesting alternate action to access service content, according to one embodiment. In one embodiment, the suggestion platform 107 performs the process 300 and is implemented in, for instance, a chip set including a processor and a memory as shown FIG. 9. FIG. 3A shows an overall process for suggesting alternate action to access service content. In step 301, the suggestion platform 107 receives a request for accessing service content. As discussed previously, the request for accessing the service content may be received when a user attempts to load a website using a web browser. The service content may be the content that is accessed to load the website, and may include a text, a picture, a Flash application, a Java application, a rich internet application (RIA) as well as digital media such as music or video. As described above, the request may also be received when (1) a web-link is selected on a page; (2) a portion of a webpage is highlighted or scrolled to, wherein the highlighted or scrolled portion may reference specific service content; (3) a user leaves the webpage; and other similar events.

After receiving the request, the suggestion platform 107 determines alternate action associated with the service content, as shown in step 303. More specifically, the suggestion platform 107 analyzes the requested service content (e.g., by parsing the URL or the service content itself) to determine matching or related alternate actions associated with service content. For example, the suggestion platform 107 may parse the service content to determine that the service content includes an email function for sharing content from the site or internet service 103. As an alternate to using the web-based messaging function provided by the internet service 103, the suggestion platform 107 may suggest using a native email client of the UE 101.

By way of example, step 303 may be performed by a local web browser plug-in that can be used to match the user's settings and filters with the request for accessing the service content. If a match is found, the matched alternate application may be suggested. In addition, in determining an alternate application, the suggestion platform 107 may determine whether the request for access the service content satisfies a policy rule. The policy rule is a condition that can be configured to determine whether the alternate application should be suggested. The policy rule may be set by the service operator of the network service or the user. For example, for a policy rule set by a user, if the user does not want any suggestions on any alternate applications, the user may set the policy rule such that no suggestions will be made. In another example, the user may set the policy rule such that an alternate application may be suggested only for websites requiring a login id and a password. The tasks of step 303 may be performed by the relevancy module 205, and the results from step 303 may be used in step 305 to suggest the alternate actions. In one example, the browser plug-in can query the relevancy module 205 in order to get the instructions on whether to suggest the alternate actions, or the relevancy module 205 can inject the updated policy rules into the plug-in. Step 303 may be supplemented by context information such as service content, data plan, location information, environmental information, etc., associated with the device, the service content or a user of the device. The alternate actions may be determined based, at least in part, on the context information. For example, if there are applications with different settings depending on the location (e.g. China v. U.S.A.), the alternate application corresponding to the location may be determined for launching to access the service content.

In step 305, once the alternate application is determined, the suggestion platform 107 suggests the alternate action for accessing the service content. By way of example, the presentation module 207 may have the web browser plug-in to present additional content such as a pop-up menu to provide an option of the suggested alternate action. The plug-in may also take into account the context information in providing the options on the pop-up menu. The alternate action may be launching of a software application capable of accessing the service content. The alternate action may also display a prompt such that the user can provide information, block access to a certain web page (e.g. parental control), or otherwise manipulate the service content. In another embodiment, the alternate action may also include modifying the content of the web page to be displayed by injecting new controls or interfaces (e.g. JavaScript), for example. Further, the alternate action may include suggesting content equivalent to the service content. This software application may be a client application that is designed specifically for the UE 101 and the website and thus provides many advantages, as discussed above. In step 307, the suggestion platform 107 performs the alternate action for accessing the service content, such that the user can start performing the alternate action to access the service content.

FIG. 3B shows one of many embodiments supported by the invention. FIG. 3B shows a detailed process for suggesting an alternate application to access the service content of the website, thus offering an alternate action to using a web browser. In step 331, the suggestion platform 107 checks whether there is an alternate application available on the device (i.e. UE 1010). If the suggestion platform 107 finds that there is no alternate application available on the device, then the suggestion platform 107 determines whether there are applications that can be downloaded, as shown in step 333. Thus, the suggestion platform 107 may conduct a search for the alternate application. The alternate applications may be downloaded from the Internet or from another device that is connected to the UE 101 over the communication network 105. The alternate applications may be made available by the website service provider or may be designed by a third party. Further, the alternate applications may be available for download at the website corresponding to the service content that the user attempts to access or at another unrelated website. If there are alternate applications available for download, the suggestion platform 107 may suggest the applications to download, as shown in step 335. Step 337 determines whether any of the suggested applications is selected for download. If one of the suggested applications is selected for download, the suggestion platform 107 downloads the application 339, and goes back to step 331.

If the suggestion platform 107 in step 331 determines that there are alternate applications available on the device, then the suggestion platform 107 suggests applications that may be selected to launch, as shown in step 341. Step 343 determines whether any of the suggested applications is selected for launch. If one of the applications is selected to be launched, then the alternate application is launched as shown in step 345. When the alternate application is launched, the alternate application may be automatically directed to access the service content that the user attempts to access in step 301. Further, when the alternate application is launched, the user information stored in the device may be automatically provided to access the service content. For example, if the user's login id and a password are stored in the device, this information may be automatically provided as the application accesses the service content of the website. On the contrary, if none of the applications is selected for launch in step 343, then the suggestion platform 107 goes to step 333 to determine whether there are other alternate applications available for download. This is advantageous in that this provides the user with ways to access other available applications if the user does not like the applications that already exist in the device. In addition, when suggesting applications to launch in step 341 or suggesting applications to download in step 335, the suggestions may be shown in a pop-up window. These suggestions may be displayed on the same window. Further, in another embodiment that is not shown, the order of step 331 (i.e. determining available applications on the device) and step 333 (i.e. determining applications available for download) may be reversed. Thus, applications available for download may be determined before checking whether there are applications available on the device. The process shown in FIG. 3B may also be customized to include additional steps. For example, an application may require a subscription, and may check whether the user or the device is subscribed or otherwise authenticated before launching the application.

In addition to client application that can be used to access service content, other types of applications may also be suggested based on the request to access the service content. By way of example, if a parent enables a parental control on the child's device and the child browses a web content that is not suitable for children, a message will appear to show that the web content is not accessible and may provide an option to request access. The option to request the access may entail sending a text message to the parent for permission. Then, the parent may approve the request such that the web content becomes accessible on the child's device. This provides advantages in that a parent can allow or deny the child's access request of the web content remotely.

The process in FIGS. 3A and 3B is advantageous in that it suggests the user to use an alternate application, which may access the service content more efficiently and provide convenience to the user, thereby enhancing the user experience and reducing network traffic load (e.g., reducing bandwidth usage). This provides an easy way for the user to be able to access the service content via the alternate application by suggesting alternate applications that can be launched from the device. Further, this process also suggests the user to download available alternate applications such that the user would easily find out about availability of the alternate applications instead of manually searching for the alternate applications for download. The suggestion platform 107 is a means for achieving these advantages.

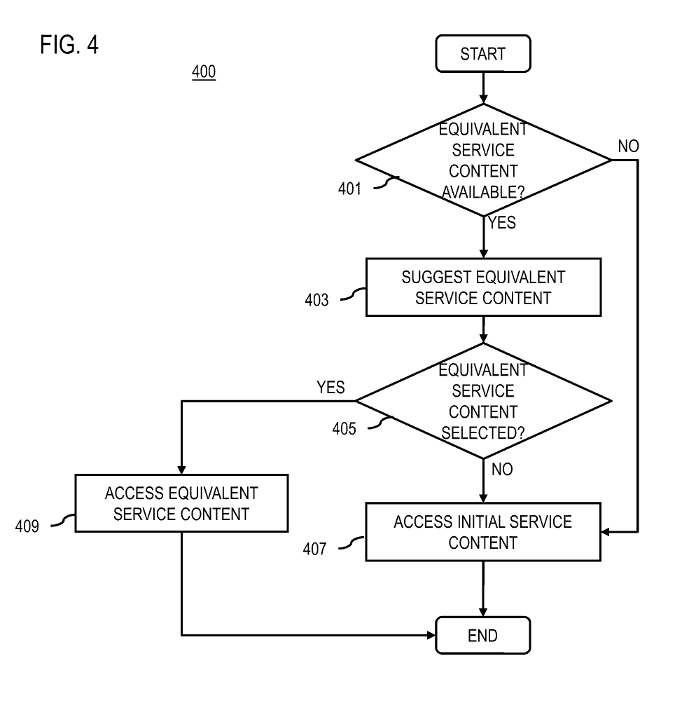

FIG. 4 is a flowchart of a process for suggesting equivalent service content, according to one embodiment. In one embodiment, the suggestion platform 107 performs the process 300 and is implemented in, for instance, a chip set including a processor and a memory as shown FIG. 9. In step 401, the suggestion platform 107 determines whether there is service content equivalent to the service content that the user initially attempts to access (i.e., initial service content). If there is no equivalent service content (e.g., a mobile-optimized version of the service content), then the suggestion platform 107 provides accessing the initial service content. If there is equivalent service content, then the suggestion platform 107 suggests accessing the equivalent service content, as shown in step 403. In step 403, the suggestion platform 107 may also apply policy rules to evaluate the need for suggesting the equivalent service content. For example, the equivalent service content may be suggested only if certain conditions are satisfied. In this example, a mobile version of the regular website may be suggested only if the network speed is relatively slow or the internet connection is expensive (e.g., when roaming, using a limited data plan, using a cellular connection, etc.). Step 405 determines whether the equivalent service content is selected to access. If the equivalent service content is selected, then the suggestion platform 107 directs to access the equivalent service content, as shown in step 409. Otherwise, the initial service content is accessed, as shown in step 407. By way of example, if a user attempts to access a regular website, the suggestion platform 107 may determine whether there is an equivalent website such as a mobile version of the regular website. This determination may be conditional. For example, a setting for the suggestion platform 107 may be configured such that the suggestion platform 107 suggests a mobile version of the website if a mobile device is used to access the website. Additionally, the determination may be based on context information (e.g., data plan, network traffic load, UE 101 location, etc.). If there is a mobile version of the website, then the suggestion platform 107 may show an option to access the mobile website. If the user selects to access the mobile website, the web browser is directed to the mobile website. Otherwise, the web browser accesses the regular website. In addition, the option of accessing equivalent service content may be displayed on the pop-up window along with suggestions for launching the alternate applications and/or suggestions for alternate applications for download.

This process is advantageous in that it suggests alternate service content to the service content the user initially attempts to access. Because alternate service content may provide different features or advantages, a user experience is enhanced with suggestions of alternate service content that the user may want to access. The suggestion platform 107 is a means for achieving this advantage.

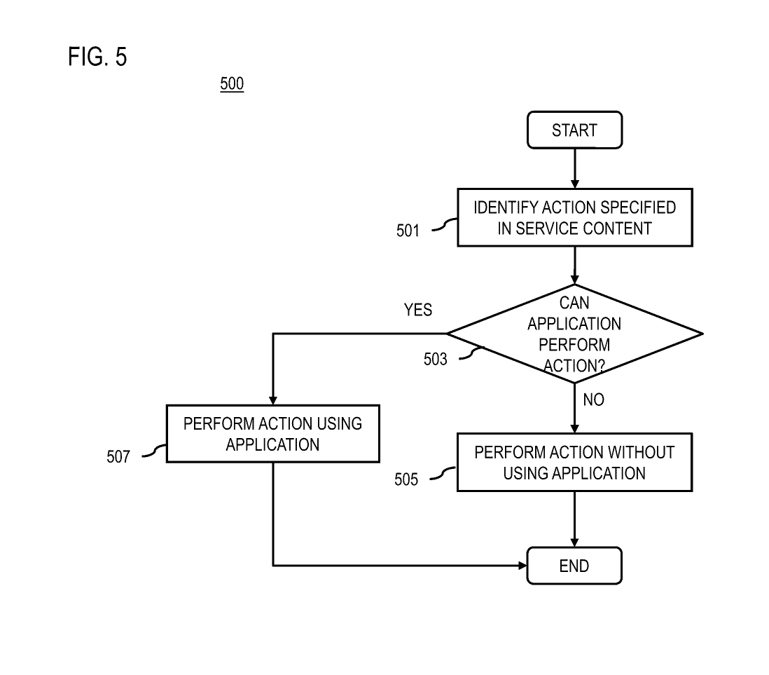

FIG. 5 is a flowchart of a process for performing an action specified in the service content using an alternate application, according to one embodiment. In one embodiment, the suggestion platform 107 performs the process 300 and is implemented in, for instance, a chip set including a processor and a memory as shown FIG. 9. In step 501, the suggestion platform 107 identifies action specified in the service content. The action may be initiated by clicking an icon corresponding to the action on a webpage. The action may be related to accessing other service contents or interacting with a webpage. For example, clicking a social networking icon corresponding to the action on the web page may lead to an action of sharing a link to the webpage on the user's social networking profile page. Then, the suggestion platform 107 determines whether the application in the device can perform the action specified in the service content, as shown in step 503. If there is an application that can perform the action, then the action is performed using the application. If there no application within the device that can perform the action, then the action is performed without using the application (e.g. using a regular web browser instead of any application), as shown in step 505.

This process is advantageous in that it provides an alternate application to perform an action specified in the website. The suggestion platform 107 is a means for achieving this advantage.

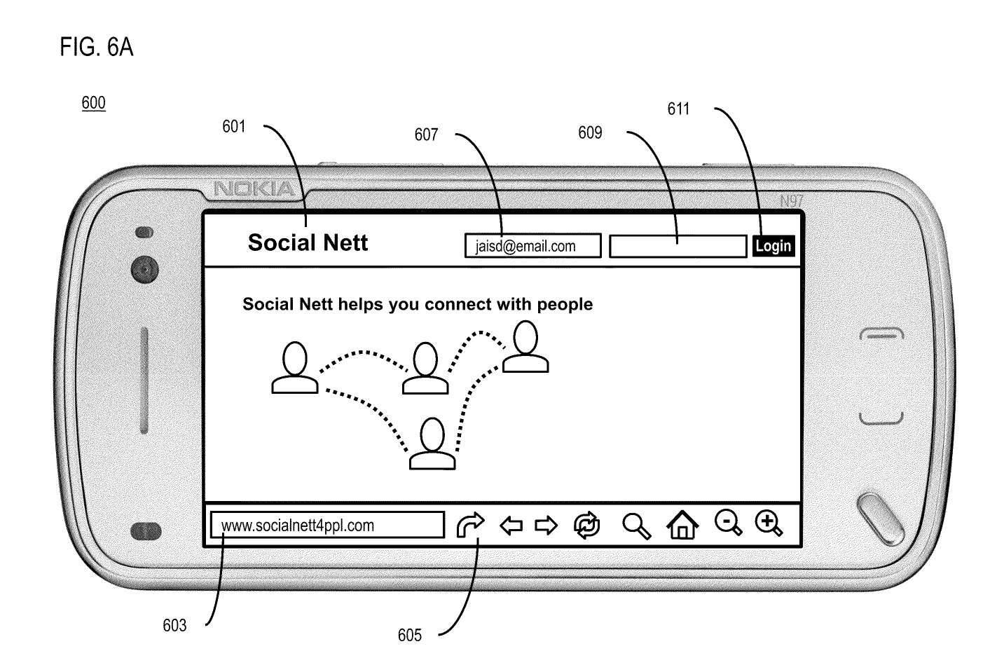

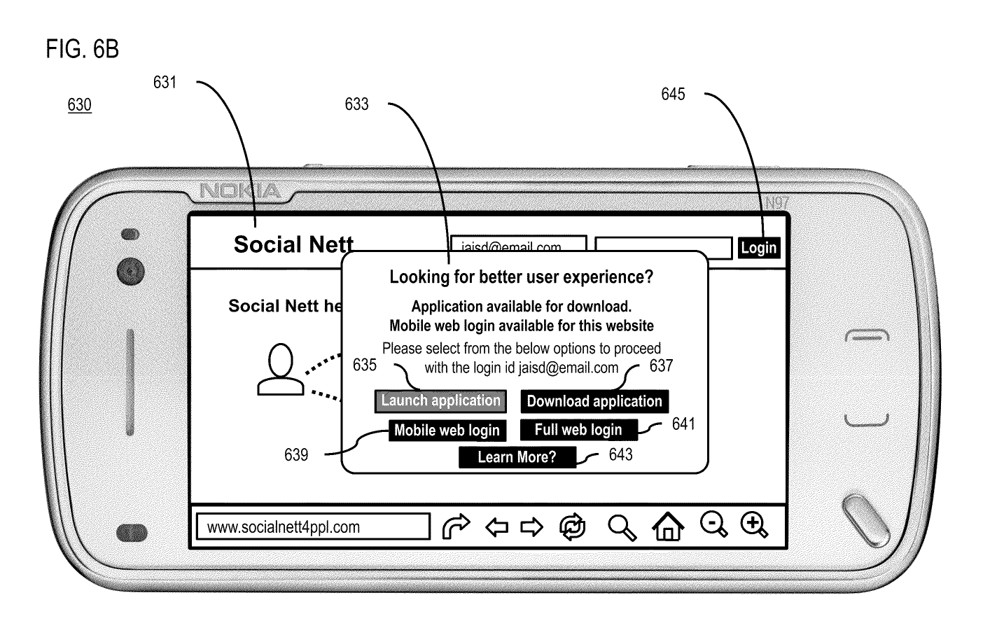

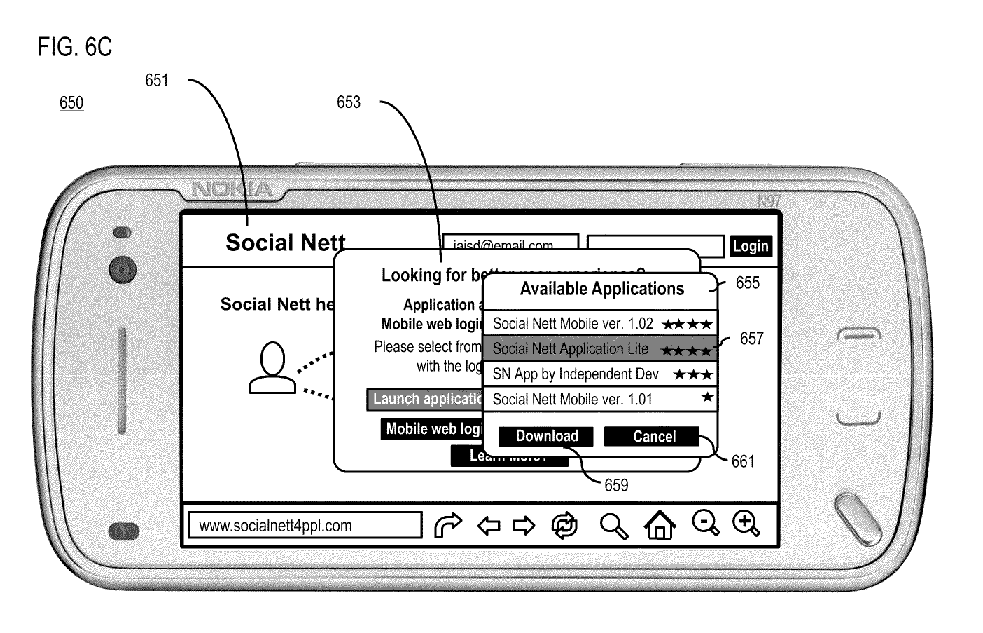

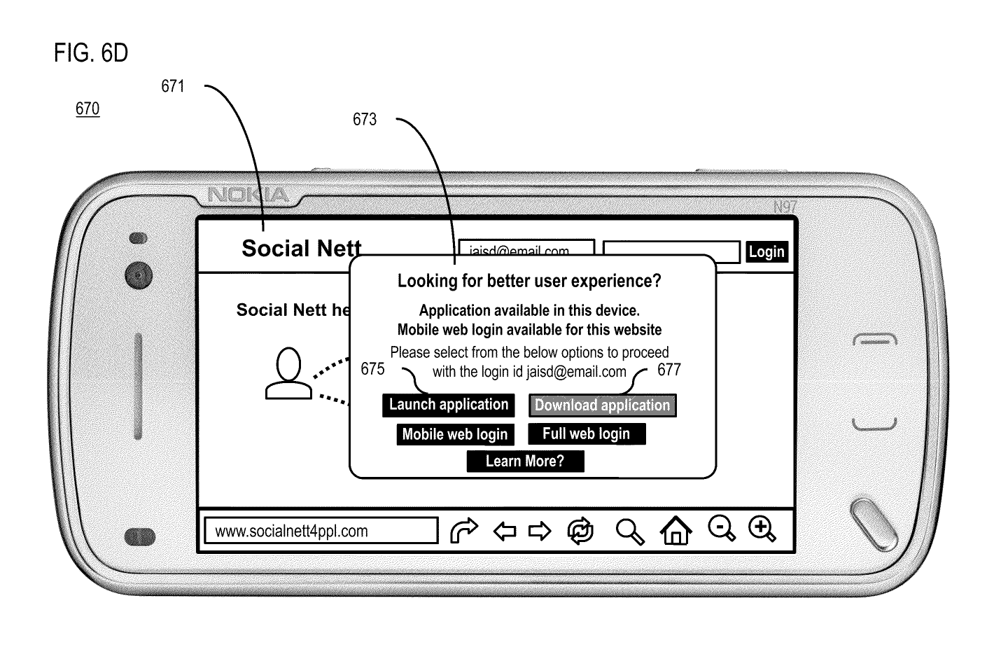

FIGS. 6A-6D are diagrams of user interfaces utilized in the processes of FIG. 3, according to various embodiments. The user interfaces in FIGS. 6A-6D are only examples of the invention, and thus the invention is not limited to the user interfaces shown in FIGS. 6A-6D. Further, the website addresses are fictitious examples, and any resemblance with existing website addresses is only coincidental. In FIG. 6A, the mobile device 600 shows a web browser 601 on the screen of the mobile device 600. The web browser 601 shows that it is on a “Social Nett” website, and the address bar 603 shows the web address for the Social Nett website. The Web browser buttons 605 are available to facilitate the web browsing. The Social Nett website has a login id slot 607 to enter a user's login id, and a password slot 609 to enter a password corresponding to the user's login id. The Social Nett website also has a login button 611 that can be selected to log into the user's Social Nett page. In FIG. 6A, the web browser 601 shows a full version of the website, as the address bar shows the web address for the full version of the Social Nett website, as opposed to a mobile version of the Social Nett website.

In FIG. 6B, the mobile device 630 shows a pop-up window 633 appearing over the web browser 631. When a user chooses the login button 645, the pop-up window 633 appears to suggest options for alternate actions to the full web login that is via the full version of the Social Nett website by entering the web address for the full version in the web browser 631. The options for alternate actions shown in the pop-up window 633 are a launch application option 635, a download application option 637, a mobile web login option 639 and a full web login option 641. The option that cannot be selected is in gray and the option that can be selected is in black. In this example, the client application is not yet installed in the mobile device 630, and thus cannot be launched in the device. Therefore, the launch application option 635 cannot be selected in this example, and is thus shown in gray. However, if the device 630 finds that there is an application available for the website (e.g. Social Nett), the device 630 determines a method to download the application to the device 630. If there is a source to download the application to the device 630, then the download application option 639 turns black and becomes available for selection. If the download application option 639 is selected, then the Social Nett application corresponding to the Social Nett website is downloaded to the device 639. After the download of the Social Nett application, the application may be automatically installed at the device 639, or another pop-up window may ask whether to install the Social Nett application or not. When the application is installed and is available for launch, the launch application option 635 turns black, and becomes available for selection. The mobile web login option 639 directs the website to a mobile website, when selected. In this example, when the mobile web login option 639 is selected, the web browser 631 is directed to a mobile version of the Social Nett website, which may be under m.socialnett4ppl.com. The mobile web login option 639 may not be available if there is no corresponding mobile web version available for the website visited by the device 630. In this case, the mobile web login option 639 may turn gray, and a user may not be able to select the mobile web login option 639. If the full web login option 641 is selected, then logging into the Social Nett account proceeds via the site at the full web address (i.e. www.socialnett4ppl.com, in this example). The learn more option 643 may be selected to display an additional pop-up window including explanations about the application and any other details on the alternate action to access the Social Nett site.

In FIG. 6C, the mobile device 650 shows a pop-up window 653 appearing over the web browser 651. Further, available application pop-up window 655 may be displayed to show a list of available applications as well as their ratings of the applications. In this case, the ratings are displayed as stars, and the applications may be listed in an order of their ratings. The user can select an application that the user wants to download. In this example, the selected application is Social Nett Application Lite, as shown in the selected application portion 657. After selecting the application, the application download button 659 may be selected to start downloading the selected application. If the user decides not to download the application, then the user may select the cancel button 661. If the cancel button 661 is selected, then the available application pop-up window 655 closes, and the user can select from the options shown in the pop-up window 653.

FIG. 6D shows an example where the application for the website is available in the device 670. FIG. 6D also shows a pop-up window 673 appearing over the web browser 671. The launch application option 675 can be selected because there is an application available in the device 670. Thus, the launch application option 675 is in black to show that this option is available for selection, unlike the launch application option 675 in FIG. 6B that is in grey. If there are multiple applications available in the device 670, then additional pop-up window (not shown) may be displayed to allow the user to select an application to launch. Alternatively, one of the multiple applications may be selected automatically, according to user preferences or ratings of the applications. The download application option 677 is not available in this example because there is no application that is available for downloading and does not exist in the device 670. Thus, the download application option 677 is in grey, to show that it is not available for selection.

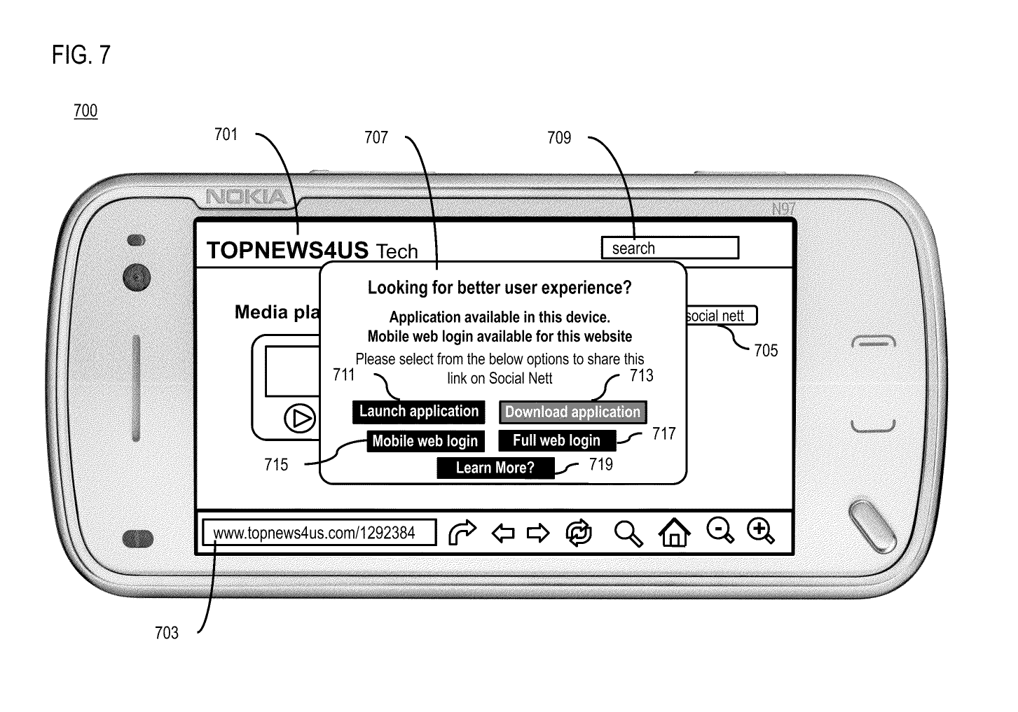

FIG. 7 is a diagram of user interfaces utilized in the processes of FIG. 3, according to various embodiments. The web browser 701 shows that the web browser is displaying Technology section of the “TOPNEWS4US” website, and displays an article and a search option 709 within the “TOPNEWS4US” website. The address bar 703 shows the web address to the full website of the TOPNEWS4US article. As shown, the website provides a clickable icon 705 for Social Nett, such that when the icon 705 is selected, the web browser is directed to the Social Nett page so that a link to the TOPNEWS4US article may be shared on the user's Social Nett page. According to this embodiment of the invention, when the clickable icon 705 for Social Nett is selected, a pop-up window 707 is displayed to suggest options for alternate actions in accessing the Social Nett page. In this example, a Social Nett application is available in the device 700, and thus the launch application option 711 is available for selection. The download application option 713 is not available because there are no applications available for download other than the applications in the device, in this example. The pop-up window 707 also has a mobile web login option 715, a full web login option 717 and a learn more option 719, which are similar to the mobile web login option 639 the full web login option 641 and the learn more option 643 in FIG. 6B.

The processes described herein for suggesting alternate action to access web content may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

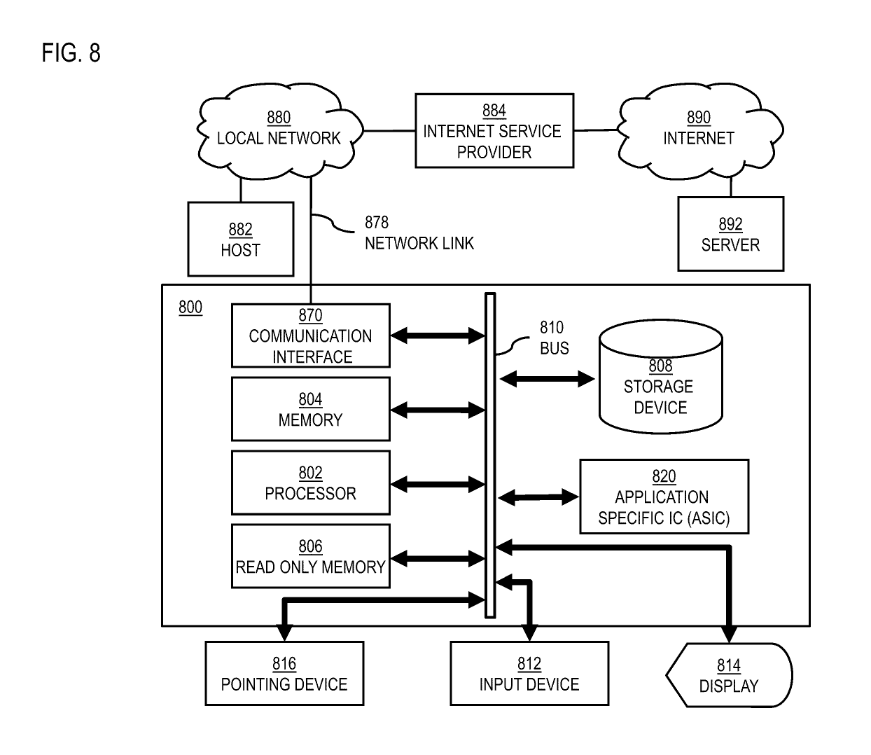

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to suggest alternate action to access service content as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of suggesting alternate action to access web content.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to suggesting alternate action to access service content. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for suggesting alternate action to access service content. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for suggesting alternate action to access service content, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for suggesting alternate action to access service content.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set 900 upon which an embodiment of the invention may be implemented. Chip set 900 is programmed to suggest alternate action to access service content as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 900, or a portion thereof, constitutes a means for performing one or more steps of suggesting alternate action to access service content.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to suggest alternate action to access service content. The memory 905 also stores the data associated with or generated by the execution of the inventive steps.

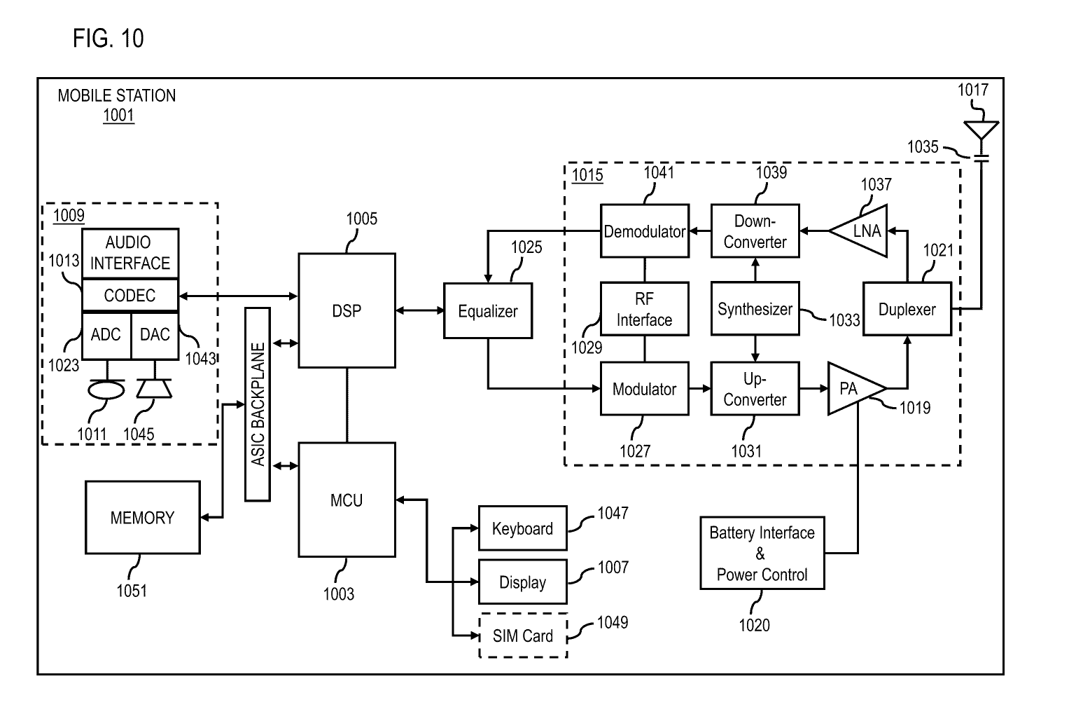

FIG. 10 is a diagram of exemplary components of a mobile terminal (e.g., handset) for communications, which is capable of operating in the system of FIG. 1, according to one embodiment. In some embodiments, mobile terminal 1000, or a portion thereof, constitutes a means for performing one or more steps of suggesting alternate action to access service content. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of suggesting alternate action to access service content. The display 10 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to suggest alternate action to access service content. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a request, from a device, for accessing service content;
determining at least one alternate action associated with the service content; and
suggesting the alternate action for accessing the service content.

2. A method of claim 1, further comprising:
causing, at least in part, presentation of a user interface of the service content; and
modifying the user interface to present the suggested alternate application.

3. A method of claim 1, further comprising:
determining context information associated with the device, the service content, a user of the device, or a combination thereof,
wherein the determining of the alternate application is based, at least in part, on the context information.

4. A method of claim 3, wherein the context information includes an address of the service content, data plan, location information, environmental information around the device and network traffic.

5. A method of claim 1, wherein the alternate action is launching an application, and the method further comprising:
receiving an input for selecting the application as the another method to access the service content;
determining whether the application is available on the device; and
causing, at least in part, retrieval of the application based on the availability determination.

6. A method of claim 1, further comprising:
identifying an action specified in the service content;
determining whether an application native to the device can perform the action; and
causing, at least in part, execution of the native application to perform the action based on the determination.

7. A method of claim 1, wherein the alternate action includes prompting the user for information, modifying the service content for display, launching an application, blocking access to the service content, suggesting content equivalent to the service content, or a combination thereof.

8. A method of claim 1, wherein the request is indicated by one of loading the service content, selecting a link in the service content, highlighting a portion of the service content, scrolling through the service content, leaving the service content, or a combination thereof.

9. An apparatus comprising:
at least one processor; and
at least one memory including computer program code,
the at least one memory and the computer program code configured to, with the at least one processor, cause the apparatus to perform at least the following,
receive a request, from a device, for accessing service content;
determine at least one alternate action associated with the service content; and
suggest the alternate action for accessing the service content.

10. An apparatus of claim 9, wherein the apparatus is further caused, at least in part, to:
cause, at least in part, presentation of a user interface of the service content; and
modify the user interface to present the suggested alternate application.

11. An apparatus of claim 9, wherein the apparatus is further caused, at least in part, to:
determine context information associated with the device, the service content, a user of the device, or a combination thereof,
wherein the determining of the alternate application is based, at least in part, on the context information.

12. An apparatus of claim 11, wherein the context information includes an address of the service content, data plan, location information, environmental information around the device and network traffic.

13. An apparatus of claim 9, wherein the alternate action is launching an application, and the apparatus is further caused, at least in part, to:
receive an input for selecting the application as the another method to access the service content;
determine whether the application is available on the device; and
cause, at least in part, retrieval of the application based on the availability determination.

14. An apparatus of claim 9, wherein the apparatus is further caused, at least in part, to:
identify an action specified in the service content;
determine whether an application native to the device can perform the action; and
cause, at least in part, execution of the native application to perform the action based on the determination.

15. A method of claim 9, wherein the alternate action includes prompting the user for information, modifying the service content for display, launching an application, blocking access to the service content, suggesting content equivalent to the service content, or a combination thereof.

16. A method of claim 9, wherein the request is indicated by one of loading the service content, selecting a link in the service content, highlighting a portion of the service content, scrolling through the service content, leaving the service content, or a combination thereof.

17. An apparatus of claim 9, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

18. A computer-readable storage medium carrying one or more sequences of one or more instructions which, when executed by one or more processors, cause an apparatus to at least perform the following steps:
receiving a request, from a device, for accessing service content;
determining at least one alternate action associated with the service content; and
suggesting the alternate action for accessing the service content.

19. A computer-readable storage medium of claim 18, wherein the alternate action is launching an application, and the apparatus is caused, at least in part, to further perform:
receiving an input for selecting the application as the another method to access the service content;
determining whether the application is available on the device; and
causing, at least in part, retrieval of the application based on the availability determination.

20. A computer-readable storage medium of claim 18, wherein the apparatus is caused, at least in part, to further perform:
identifying an action specified in the service content;
determining whether an application native to the device can perform the action; and
causing, at least in part, execution of the native application to perform the action based on the determination.
